(19) United States
(12) Patent Application Publication
(10) Pub. No.: US 2015/0068307 A1
(43) Pub. Date: Mar. 12, 2015

(54) RESONANCE DEVICE HAVING DROP RESISTIVE PROTECTION

(71) Applicant: Ming-Ching Wu, Taoyuan County (TW)

(72) Inventor: Ming-Ching Wu, Taoyuan County (TW)

(73) Assignee: GlobalMEMS Co., Ltd., Bandar Seri Begawan (BN)

(21) Appl. No.: 14/069,387

(22) Filed: Nov. 1, 2013

(30) Foreign Application Priority Data
Sep. 10, 2013 (TW) 102132601

(51) Int. Cl. G01C 19/5712

(52) U.S. Cl. CPC G01C 19/5712
USPC 73/504.12

(57) ABSTRACT

A resonance device includes a base, a mass, a plurality of elastic portions and at least one end surface. The mass has at least one end surface. The elastic portions are connected between the mass and the base, in which the mass is adapted to resonate in a first direction such that the elastic portions are elastically deformed. The block portion is disposed at the base and extends towards the end surface to be aligned to the end surface, in which the gap between the base and the end surface in the first direction is greater than the gap between the block portion and the end surface in the first direction, and the block portion is adapted to block the end surface to limit the moving range of the mass.

### CROSS-REFERENCE TO RELATED APPLICATION

This application claims the priority benefit of Taiwan application serial no. 102132601, filed on Sep. 10, 2013. The entirety of the above-mentioned patent application is hereby incorporated by reference herein and made a part of this specification.

### BACKGROUND OF THE INVENTION

1. Field of the Invention

The invention generally relates to a resonance device, and more particularly, to a resonance device having drop resistive protection.

2. Description of Related Art

In recent years, along with development of electronic products such as smart phones, tablet PCs and somatosensory game machines, etc., micro-electromechanical system (MEMS) inertial sensors such as accelerometers and gyroscopes, etc. are widely applied in the aforementioned electronic products, and a market demand thereof has grown significantly year by year. Under intense market competition, related applications of the MEMS inertial sensors have higher demand on quality of the MEMS inertial sensors. Regarding a piezo-resistive accelerometer, acceleration of an apparatus is measured through a resistance variation amount of a component therein.

FIG. 1 is a schematic cross-sectional diagram of a conventional known practice an MEMS gyroscope and FIG. 2 is a top-view diagram of partial parts of the gyroscope in FIG. 1. Referring to FIGS. 1 and 2, a mass 52 of a gyroscope 50 is connected to a connection portion 56a of a base 56 through elastic portions 54. By means of the elastic deformation characteristic of the elastic portions 54, the mass 52 is driven to be resonated, and further the Coriolis force during rotating of the gyroscope 50 is measured in the resonance operation mode so as to calculate the angular velocity of the gyroscope 50, wherein the detection and calculation principle is known in the related technical field. U.S. Pat. No. 5,668,318, for example, discloses the related MEMS gyroscope technology.

When the apparatus drops, if the mass 52 in the gyroscope 50 instantly generates a large displacement due to an impact force of the drop, the elastic portion 54 is probably damaged due to excessive pulling. In this way, in some drop resistive designs, a moving range of the mass 52 can be limited by decreasing a gap G1 between a first base body 56b and the mass 52 and decreasing a gap G2 between a second base body 56c and the mass 52, so as to avoid the mass 52 from instantly generating a large displacement due to the impact force caused by drop of the mass 52. However, when the gaps G1 and G2 are small, an excessive damping effect caused by the air between the mass 52 and the first base body 56b, which reduces the resonance respond of the mass 52 due to the air damping and the measuring sensitivity and accuracy of the angular velocity of the gyroscope 50.

### SUMMARY OF THE INVENTION

Accordingly, the invention is directed to a resonance device with good resonance capability and drop resistive protection function.

A resonance device of the invention includes a base, a mass, a plurality of elastic portions and at least one end surface. The mass has at least one end surface. The elastic portions are connected between the mass and the base, in which the mass is adapted to resonate in a first direction such that the elastic portions are elastically deformated. The block portion is disposed at the base and extends towards the end surface to be aligned to the end surface, in which the gap between the base and the end surface in the first direction is greater than the gap between the block portion and the end surface in the first direction, and the block portion is adapted to block the end surface to limit the moving range of the mass.

In an embodiment of the invention, the base includes a first base body, a second base body and a connection portion. The mass is located between the first base body and the second base body and the block portion is fixed at the first base body or the second base body. The connection portion is fixed between the first base body and the second base body, in which each of the elastic portions is connected between the mass and the connection portion.

In an embodiment of the invention, the connection portion is adhered to the first base body and the second base body.

In an embodiment of the invention, a number of the at least one block portion is plural, the at least one end surface includes a top surface of the mass and a bottom surface of the mass, a part of the block portions are aligned to the top surface and another part of the block portions are aligned to the bottom surface.

In an embodiment of the invention, the resonance device further includes at least one block structure, in which the mass has a plurality of side surfaces, the elastic portions are respectively connected to the side surfaces, the block structure is disposed at the base and aligned to at least one side surface, and the block portion is adapted to block the corresponding end surface to limit the moving range of the mass.

In an embodiment of the invention, the base includes a first base body, a second base body and a connection portion, the mass is located between the first base body and the second base body, the connection portion is fixed between the first base body and the second base body and the block structure is fixed at the first base body or the second base body, the connection portion is adhered to the first base body in the first direction, the connection portion is adhered to the second base body in the first direction, and each of the side surfaces is parallel to the first direction.

In an embodiment of the invention, a number of the at least one block portion is plural, and the block portions are respectively aligned to the side surfaces.

In an embodiment of the invention, the block structure has two block surfaces, and the two block surfaces are respectively aligned to the two adjacent side surfaces.

In an embodiment of the invention, the block structure extends from the block portion.

In an embodiment of the invention, the length of the block structure in the first direction is greater than the gap between the block portion and the end surface in the first direction.

In an embodiment of the invention, the end surface is perpendicular to each of the side surfaces, the block structure is adapted to block the corresponding side surface to limit the moving range of the mass in a second direction, and the second direction is inclined to each of the side surfaces and the end surface.

In an embodiment of the invention, each of the elastic portions extends in an axis and the axis does not pass through mass center of the mass.

In an embodiment of the invention, the block portion is formed through an exposure process and an etching process.

Based on the depiction above, the resonance device of the invention has block portions on the base thereof able to block the end surface of the mass to limit the moving range of the mass, such that the mass is avoided to have an instant large displacement due to the dropping impact force, so as to avoid a pulling damage of the elastic portions due to excessive displacement of the mass. In this way, the drop resistive protection function can be realized. Since in the resonance device of the invention, the mass is blocked to limit the moving range of the mass by using the block portions on the base, there is no need to reduce the gap between the whole base and the end surface of the mass for blocking the mass. As a result, the damping effect caused by the air between the end surface of the mass and the base is not excessive so as to ensure a smooth resonance of the mass.

In order to make the features and advantages of the present invention more comprehensible, the present invention is further described in detail in the following with reference to the embodiments and the accompanying drawings.

### BRIEF DESCRIPTION OF THE DRAWINGS

FIG. 1 is a schematic cross-sectional diagram of a conventional MEMS gyroscope.

FIG. 2 is a top-view diagram of partial parts of the gyroscope in FIG. 1.

FIG. 3 is a schematic cross-sectional diagram of a resonance device according to an embodiment of the invention.

FIG. 4 is a top-view diagram of partial parts of the gyroscope in FIG. 3.

FIG. 5 is a schematic cross-sectional diagram of a resonance device according to another embodiment of the invention.

FIG. 6 is a top-view diagram of partial parts of the gyroscope in FIG. 5.

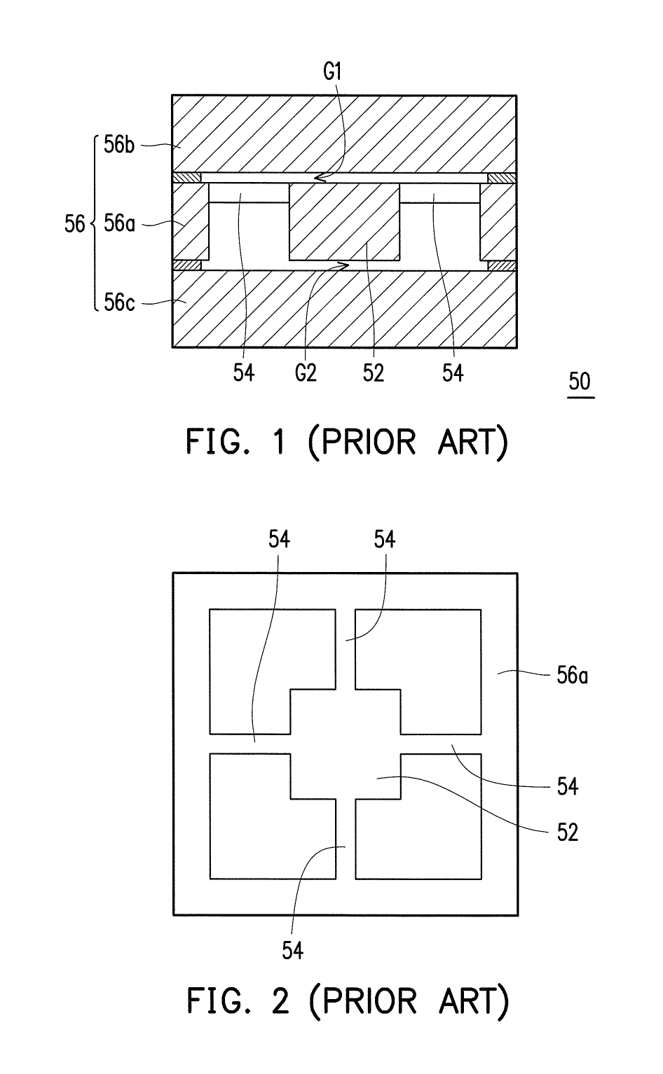

### DESCRIPTION OF THE EMBODIMENTS

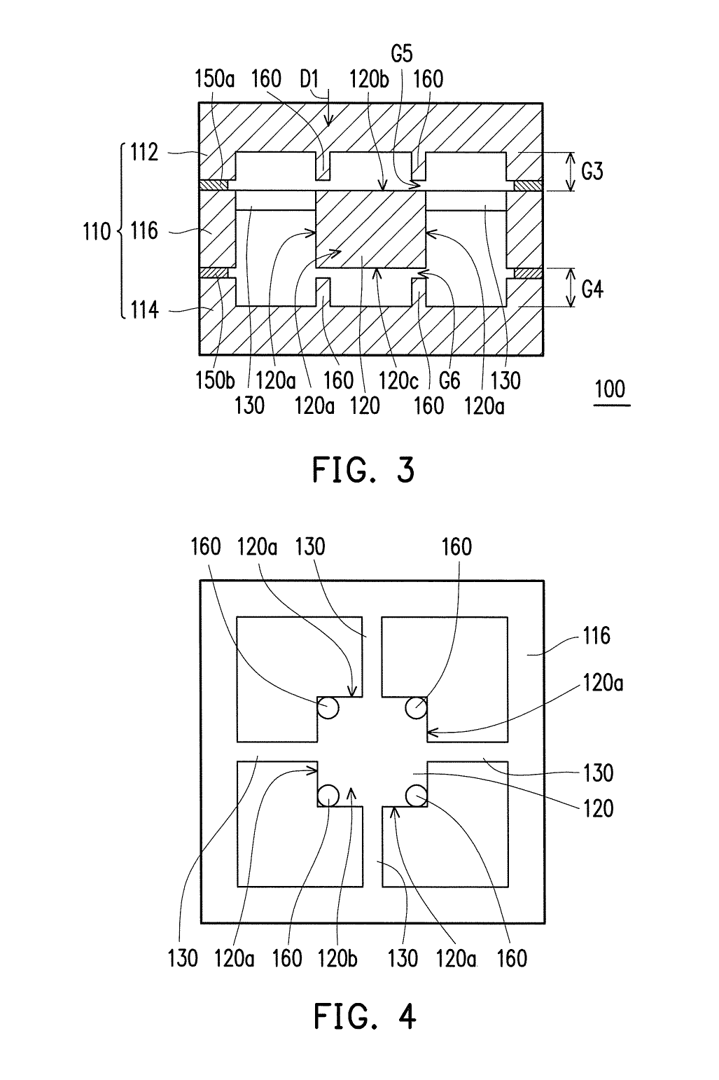

FIG. 3 is a schematic cross-sectional diagram of a resonance device according to an embodiment of the invention and FIG. 4 is a top-view diagram of partial parts of the gyroscope in FIG. 3. Referring to FIGS. 3 and 4, a resonance device 100 of the embodiment is, for example, an MEMS gyroscope and includes a base 110, a mass 120 and a plurality of elastic portions 130. The base 110 includes a first base body 112, a second base body 114 and a connection portion 116. The connection portion 116 and the first base body 112 are adhered to each other in a first direction D1 as shown in FIG. 3 through an adhesive 150a and the connection portion 116 and the second base body 114 are adhered to each other in the first direction D1 through an adhesive 150b, so that the connection portion 116 is fixed between the first base body 112 and the second base body 114. The mass 120 is located between the first base body 112 and the second base body 114 and has a plurality of side surfaces 120a and two opposite end surfaces, in which the two end surfaces are the top surface 120b and bottom surface 120c of the mass 120 and are perpendicular to each of the side surfaces 120a.

The elastic portions 130 are respectively connected to the side surfaces 120a and connected to the connection portion 116 of the base 110. The base 110 is to be driven in the first direction D1 to resonate such that the elastic portions 130 are elastically deformed. In such resonance operation mode, the Coriolis force of the resonance device 100 during rotating can be measured to further calculate the angular velocity of a device with the resonance device 100, wherein the detection and calculation principle is a known technique of the belonging field, which is omitted to describe.

The resonance device 100 of the embodiment further includes a plurality of block portions 160, the partial block portions 160 are fixed at the first base body 112 and extend towards the top surface 120b of the mass 120 to be aligned to the top surface 120b, while the rest block portions 160 are fixed at the second base body 114 and extend towards the bottom surface 120c of the mass 120 to be aligned to the bottom surface 120c. The gap G3 between the base 110 and the top surface 120b of the mass 120 in the first direction D1 is greater than the gap G5 between the block portions 160 and the top surface 120b of the mass 120, and the gap G4 between the base 110 and the bottom surface 120c of the mass 120 in the first direction D1 is greater than the gap G6 between the block portions 160 and the bottom surface 120c of the mass 120 in the first direction D1.

Under the above configuration, the block portions 160 are able to block the top surface 120b and bottom surface 120c of the mass 120 to limit the moving range of the mass 120, such that the mass 120 is avoided to have an instant large displacement due to a dropping impact force, so as to avoid a pulling damage of the elastic portions 130 due to an excessive displacement of the mass 120. As a result, the drop resistive protection function is realized. Since in the resonance device of the embodiment, the mass 120 is blocked to limit the moving range of the mass 120 by using the block portions 160 on the base 110, there is no need to reduce the gaps between the whole base 110 and the top surface 120b and bottom surface 120c of the mass 120 for blocking the mass 120. Thus, the base 110 and the mass 120 have larger gaps G3 and G4. As a result, the damping effect caused by the air between the base 110 and the mass 120 is not excessive so as to ensure the mass 120 smoothly making resonance. The invention does not limit the number and arrangement way of the block portions 160. In other embodiments, the block portions 160 can have other appropriate number and other arrangement ways. In addition, in other embodiments, the resonance device 100 can be a quartz crystal oscillator or other resonance devices, which the invention is not limited to.

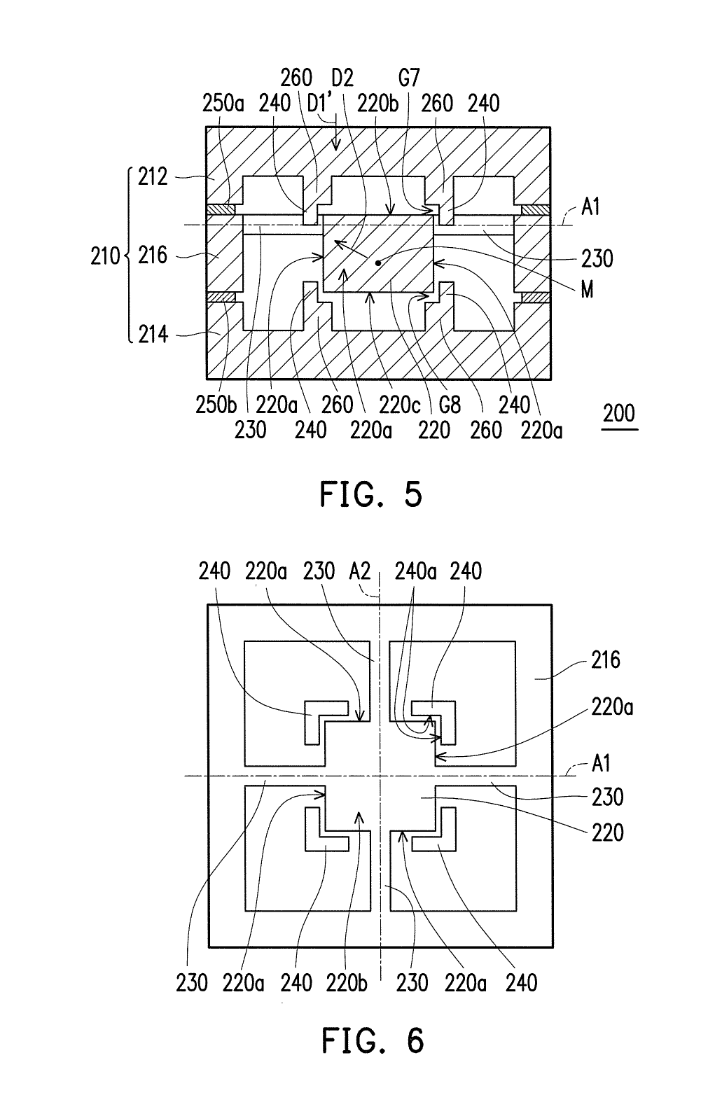

FIG. 5 is a schematic cross-sectional diagram of a resonance device according to another embodiment of the invention and FIG. 6 is a top-view diagram of partial parts of the gyroscope in FIG. 5. In the resonance device 200 of FIG. 5, the dispositions and the action ways of a base 210, a first base body 212, a second base body 214, a connection portion 216, a mass 220, elastic portions 230, an adhesive 250a, an adhesive 250b and block portions 260 are the same as the dispositions and the action ways of the base 110, the first base body 112, the second base body 114, the connection portion 116, the mass 120, the elastic portions 130, the adhesive 150a, the adhesive 150b and the block portions 160, which are omitted to describe. The difference of the resonance device 200 from the resonance device 100 rests in that the resonance device 200 further includes a plurality of block structures 240. The partial block structures 240 are disposed at the first base body 212 and the rest block structures 240 are disposed at the second base body 214. As shown in FIG. 5, these block structures 240 are respectively extended from the block portions 260, and the length of the block structures 240 in the first direction D1′ is greater than the gap G7 between the block portions 260 and the top surface 220b of the mass 220 in the first direction D1′ and greater than the gap G8 between the block portions 260 and the bottom surface 220c of the mass 220 in the first direction D1′, so that these block structures 240 can be respectively aligned to the side surfaces 220a of the mass 220, in which each of the block structures 240, for example, has two block surfaces 240a respectively aligned to the two adjacent side surfaces 220a.

Under the above configuration, the block structures 240 are able to block the side surfaces 220a of the mass 220 to limit the moving range of the mass 220, such that the mass 220 is avoided to have an instant large displacement due to a dropping impact force, so as to avoid a pulling damage of the elastic portions 230 due to an excessive displacement of the mass 220. The block structures 240 can be formed by using an exposure process or an etching process so as to have better dimension accuracy and make the gap between the block structures 240 and the side surfaces 220a of the mass 220 appropriate, which can accurately limit the moving range of the mass 220 to advance the drop resistive protection function of the resonance device 200.

In more details, the connection portion 216 and the first base body 212 are adhered to each other through the adhesive 250a in the first direction D1′ as shown in FIG. 5, and the connection portion 216 and the second base body 214 are adhered to each other through the adhesive 250b in the first direction D1′. Each of the side surfaces 220a of the mass 220 is parallel to the first direction D1′. Thus, the dimension error produced when the first base body 212 and second base body 214 are adhered to the connection portion 216 unlikely affects the accuracy of the gaps between all the side surfaces 220a and the block structures 240.

In the embodiment, partial elastic portions 230 extend in an axis A1 (referring to FIGS. 5 and 6), while the rest elastic portions 230 extend in another axis A2 (referring to FIG.

6), wherein both the axis A1 and the axis A2 do not pass through the mass center M of the mass 220. Therefore, when the mass 220 suffers a dropping impact force, the mass 220 easily has a displacement along an inclined direction. The inclined direction can be, for example, the second direction D2 in FIG. 5 or other inclined directions. In particular, the inclined direction is the one inclined to each of the side surfaces 220a, the top surface 220b and the bottom surface 220c of the mass 220. When the mass 220 has displacement along the inclined direction, the block structures 240 are suitable to block the side surfaces 220a of the mass 220 to limit the moving range of the mass 220 along the inclined direction, which can avoid the dragging and damaging of the elastic portions 230 caused by the excessive displacement of the mass 220 in the first direction D1′.

In summary, the resonance device of the invention has block portions on the base thereof able to block the end surface of the mass to limit the moving range of the mass, such that the mass is avoided to have an instant large displacement due to the dropping impact force, so as to avoid a pulling damage of the elastic portions due to excessive displacement of the mass. In this way, the drop resistive protection function can be realized. Since in the resonance device of the invention, the mass is blocked to limit the moving range of the mass by using the block portions on the base, there is no need to reduce the gap between the whole base and the end surface of the mass for blocking the mass. As a result, the damping effect caused by the air between the base and the end surface of the mass is not excessive so as to ensure a smooth resonance of the mass. In addition, by further disposing the block structures on the block portions of the resonance device, the side surfaces of the mass are blocked by the block structures so as to limit the moving range of the mass and further increase the drop resistive protection function.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A resonance device, comprising:
a base;
a mass, having at least one end surface;
a plurality of elastic portions, connected between the mass and the base, wherein the mass is adapted to resonate in a first direction such that the elastic portions are elastically deformed; and
at least one block portion, disposed at the base and extending towards the end surface to be aligned to the end surface, wherein a gap between the base and the end surface in the first direction is greater than a gap between the block portion and the end surface in the first direction, and the block portion is adapted to block the end surface to limit a moving range of the mass.

2. The resonance device as claimed in claim 1, wherein the base comprises:
a first base body;
a second base body, wherein the mass is located between the first base body and the second base body, and the block portion is fixed at the first base body or the second base body; and
a connection portion, fixed between the first base body and the second base body, wherein each of the elastic portions is connected between the mass and the connection portion.

3. The resonance device as claimed in claim 2, wherein the connection portion is adhered to the first base body and the second base body.

4. The resonance device as claimed in claim 1, wherein a number of the at least one block portion is plural, the at least one end surface comprises a top surface of the mass and a bottom surface of the mass, a part of the block portions are aligned to the top surface and another part of the block portions are aligned to the bottom surface.

5. The resonance device as claimed in claim 1, further comprising at least one block structure, wherein the mass has a plurality of side surfaces, the elastic portions are respectively connected to the side surfaces, the block structure is disposed at the base and aligned to at least one of the side surfaces, and the block portion is adapted to block the corresponding side surface to limit the moving range of the mass.

6. The resonance device as claimed in claim 5, wherein the base comprises a first base body, a second base body and a connection portion, the mass is located between the first base body and the second base body, the connection portion is fixed between the first base body and the second base body, the block structure is fixed at the first base body or the second base body, the connection portion is adhered to the first base body in the first direction, the connection portion is adhered to the second base body in the first direction, and each of the side surfaces is parallel to the first direction.

7. The resonance device as claimed in claim 5, wherein a number of the at least one block portion is plural, and the block portions are respectively aligned to the side surfaces.

8. The resonance device as claimed in claim 5, wherein the block structure has two block surfaces, and the two block surfaces are respectively aligned to the two adjacent side surfaces.

9. The resonance device as claimed in claim 5, wherein the block structure extends from the block portion.

10. The resonance device as claimed in claim 9, wherein a length of the block structure in the first direction is greater than the gap between the block portion and the end surface in the first direction.

11. The resonance device as claimed in claim 5, wherein the end surface is perpendicular to each of the side surfaces, the block structure is adapted to block the corresponding side surface to limit the moving range of the mass in a second direction, and the second direction is inclined to each of the side surfaces and the end surface.

12. The resonance device as claimed in claim 1, wherein each of the elastic portions extends in an axis and the axis does not pass through a mass center of the mass.

13. The resonance device as claimed in claim 1, wherein the block portion is formed through an exposure process and an etching process.
